(19) United States
(12) Patent Application Publication
(10) Pub. No.: US 2024/0413403 A1
(43) Pub. Date: Dec. 12, 2024

(54) Battery

(71) Applicant: ZHUHAI COSMX BATTERY CO., LTD., Zhuhai (CN)

(72) Inventors: Yingdi MU, Zhuhai (CN); Zulai ZHANG, Zhuhai (CN); Hai WANG, Zhuhai (CN); Suli LI, Zhuhai (CN); Junyi ZHAO, Zhuhai (CN); Junyi LI, Zhuhai (CN)

(73) Assignee: ZHUHAI COSMX BATTERY CO., LTD., Zhuhai (CN)

(21) Appl. No.: 18/398,798

(22) Filed: Dec. 28, 2023

Related U.S. Application Data
(63) Continuation-in-part of application No. PCT/CN2022/127500, filed on Oct. 25, 2022.
(63) Continuation-in-part of application No. PCT/CN2022/127437, filed on Oct. 25, 2022.
(63) Continuation-in-part of application No. PCT/CN2022/127488, filed on Oct. 25, 2022.
(63) Continuation-in-part of application No. PCT/CN2022/127482, filed on Oct. 25, 2022.

(30) Foreign Application Priority Data
Oct. 25, 2021 (CN) 202111251998.9
Oct. 25, 2021 (CN) 202111252287.3
Oct. 25, 2021 (CN) 202111252288.8
Oct. 25, 2021 (CN) 202111262962.0

(51) Int. Cl. H01M 10/0569; H01M 4/02; H01M 4/131; H01M 4/133; H01M 4/525; H01M 4/583; H01M 10/0567; H01M 10/0568; H01M 50/434; H01M 50/451

(52) U.S. Cl. CPC H01M 10/0569; H01M 4/131; H01M 4/133; H01M 4/525; H01M 4/583; H01M 10/0567; H01M 10/0568; H01M 50/434; H01M 50/451; H01M 2004/027; H01M 2004/028

(57) ABSTRACT

A battery includes a positive electrode plate, a negative electrode plate, a separator, and a non-aqueous electrolyte solution. The non-aqueous electrolyte solution includes a non-aqueous organic solvent including at least ethyl propionate. The separator includes a substrate, a heat-resistant layer, and an adhesive layer, where the heat-resistant layer is disposed on at least one side of the substrate, and the adhesive layer is disposed on the heat-resistant layer. The adhesive layer includes an adhesive including a copolymer of hexafluoropropylene-vinylidene fluoride. A ratio of a mass percentage of ethyl propionate in the non-aqueous electrolyte solution to a mass percentage of hexafluoropropylene in the copolymer of hexafluoropropylene-vinylidene fluoride ranges from 0.2 to 60. The battery in the present disclosure has both a long cycle life and low expansion.

### CROSS-REFERENCE TO RELATED APPLICATIONS

The present disclosure is a continuation-in-part of International Application No. PCT/CN2022/127482, filed on Oct. 25, 2022, which claims priority to Chinese Patent Application No. 202111252288.8, filed on Oct. 25, 2021. The present disclosure is also a continuation-in-part of International Application No. PCT/CN2022/127488, filed on Oct. 25, 2022, which claims priority to Chinese Patent Application No. 202111252287.3, filed on Oct. 25, 2021. The present disclosure is also a continuation-in-part of International Application No. PCT/CN2022/127437, filed on Oct. 25, 2022, which claims priority to Chinese Patent Application No. 202111251998.9, filed on Oct. 25, 2021. The present disclosure is also a continuation-in-part of International Application No. PCT/CN2022/127500, filed on Oct. 25, 2022, which claims priority to Chinese Patent Application No. 202111262962.0, filed on Oct. 25, 2021. The contents of all of the above applications are incorporated by reference into the present disclosure.

### TECHNICAL FIELD

The present disclosure pertains to the field of battery technologies, and specifically, relates to a battery.

### BACKGROUND

In recent years, lithium-ion batteries have been widely used in smartphones, tablet computers, intelligent wearing, electric tools, electric vehicles, and other fields. With extensive application of lithium-ion batteries, consumers have an increasing requirement for a lifespan of lithium-ion batteries. This requires lithium-ion batteries to have a long cycle life.

Currently, there are potential safety hazards in the use of lithium-ion batteries. For example, when a battery is used for a long time, a thickness of the battery will increase due to expansion, which may easily lead to serious safety accidents, such as fire or even explosion. One of the main reasons for the above problem is that as a cycle time of the battery increases, an interface between a separator and an electrode plate becomes worse. The main reason for the deterioration of the interface between the separator and the electrode plate is that an adhesive strength of the separator decreases as the cycle time increases.

In view of this current situation, there is an urgent need to develop a lithium-ion battery with a long cycle life and low expansion.

### SUMMARY

An objective of the present disclosure is to provide a battery that has both a long cycle life and low expansion, so as to resolve the above problem existing in the prior art.

To achieve the foregoing objective, the following technical solution is used in the present disclosure.

A battery includes a positive electrode plate, a negative electrode plate, a separator disposed between the positive electrode plate and the negative electrode plate, and a non-aqueous electrolyte solution. The non-aqueous electrolyte solution includes a non-aqueous organic solvent including at least ethyl propionate (EP). The separator includes a substrate, a heat-resistant layer, and an adhesive layer, where the heat-resistant layer is disposed on at least one side of the substrate, and the adhesive layer is disposed on the heat-resistant layer. The adhesive layer includes an adhesive including a copolymer of hexafluoropropylene-vinylidene fluoride. A ratio of a mass percentage of ethyl propionate in the non-aqueous electrolyte solution to a mass percentage of hexafluoropropylene (HFP) in the copolymer of hexafluoropropylene-vinylidene fluoride ranges from 0.2 to 60, with an example of 0.2, 0.26, 0.5, 1, 2.4, 5.8, 9.2, 11.3, 13.7, 15, 20, 30, 35, 36.7, 40, 50, 60, or any point value within a range consisting of any two of the above point values.

In one example, the heat-resistant layer is disposed oppositely on both sides of the substrate.

In one example, a ratio of a mass percentage of ethyl propionate in the non-aqueous electrolyte solution to a mass percentage of hexafluoropropylene in the copolymer of hexafluoropropylene-vinylidene fluoride ranges from 0.5 to 35.

In one example, a ratio of a mass percentage of ethyl propionate in the non-aqueous electrolyte solution to a mass percentage of hexafluoropropylene in the copolymer of hexafluoropropylene-vinylidene fluoride ranges from 14 to 40.

In one example, the heat-resistant layer is disposed oppositely on both sides of the substrate.

### <Separator>

In the present disclosure, the copolymer of hexafluoropropylene-vinylidene fluoride is, for example, a copolymer of polyvinylidene fluoride-hexafluoropropylene. The “copolymer of polyvinylidene fluoride-hexafluoropropylene” refers to hexafluoropropylene modified polyvinylidene fluoride.

In the present disclosure, the mass percentage of hexafluoropropylene refers to a percentage by mass of a sum of all hexafluoropropylene units in the copolymer of hexafluoropropylene-vinylidene fluoride.

The copolymer of hexafluoropropylene-vinylidene fluoride has a number average molecular weight of 200,000 Da to 2,500,000 Da, with an example of 200,000 Da, 300,000 Da, 400,000 Da, 500,000 Da, 600,000 Da, 700,000 Da, 800,000 Da, 1,000,000 Da, 2,000,000 Da, 2,500,000 Da, or any point value within a range consisting of any two of the above point values.

In one example, the copolymer of hexafluoropropylene-vinylidene fluoride has a number average molecular weight of 500,000 Da to 2,500,000 Da.

In one example, the copolymer of hexafluoropropylene-vinylidene fluoride has a number average molecular weight of 500,000 Da to 2,000,000 Da.

A sum of molecular weights of vinylidene fluoride units in the copolymer of hexafluoropropylene-vinylidene fluoride ranges from 200,000 Da to 2,000,000 Da, with an example of 200,000 Da, 300,000 Da, 400,000 Da, 500,000 Da, 600,000 Da, 700,000 Da, 800,000 Da, 1,000,000 Da, 2,000,000 Da, or any point value within a range consisting of any two of the above point values.

In one example, the sum of the molecular weights of the vinylidene fluoride units in the copolymer of hexafluoropropylene-vinylidene fluoride ranges from 500,000 Da to 2,000,000 Da.

The polyvinylidene fluoride (PVDF) has a number average molecular weight of 500,000 Da to 2,000,000 Da, with an example of 500,000 Da, 600,000 Da, 700,000 Da, 800,000 Da, 1,000,000 Da, 2,000,000 Da, or any point value within a range consisting of any two of the above point values.

The mass percentage of hexafluoropropylene in the copolymer of hexafluoropropylene-vinylidene fluoride ranges from 1 wt. % to 25 wt. %, with an example of 1 wt. %, 1.5 wt. %, 2 wt. %, 2.5 wt. %, 3 wt. %, 3.5 wt. %, 5 wt. %, 6.5 wt. %, 9 wt. %, 10 wt. %, 15 wt. %, 20 wt. %, 23 wt. %, 25 wt. %, or any point value within a range consisting of any two of the above values.

In one example, the mass percentage of hexafluoropropylene in the copolymer of hexafluoropropylene-vinylidene fluoride ranges from 1.5 wt. % to 15 wt. %.

The heat-resistant layer includes ceramic and a binder.

A mass percentage of the ceramic in the heat-resistant layer ranges from 20 wt. % to 99 wt. %, with an example of 20 wt. %, 30 wt. %, 40 wt. %, 60 wt. %, 80 wt. %, 90 wt. %, 95 wt. %, 99 wt. %, or any point value within a range consisting of any two of the above values.

A mass percentage of the binder in the heat-resistant layer ranges from 1 wt. % to 80 wt. %, with an example of 1 wt. %, 5 wt. %, 10 wt. %, 20 wt. %, 30 wt. %, 50 wt. %, 60 wt. %, 80 wt. %, or any point value within a range consisting of any two of the above values.

The ceramic is selected from at least one of aluminum oxide, boehmite, magnesium oxide, boron nitride, or magnesium hydroxide.

The binder is selected from at least one of polytetrafluoroethylene, polyvinylidene fluoride, copolymer of hexafluoropropylene-vinylidene fluoride (such as copolymer of polyvinylidene fluoride-hexafluoropropylene), polyimide, polyacrylonitrile, or polymethyl methacrylate.

The adhesive layer has a thickness of 0.5 μm to 2 μm, with an example of 0.5 μm, 1 μm, or 2 μm.

A solvent used in the heat-resistant layer and the adhesive layer is selected from at least one of acetone, tetrahydrofuran, dichloromethane, chloroform, dimethylformamide, N-methyl-2-pyrrolidone, cyclohexane, methanol, ethanol, isopropanol, or water.

In one example, the adhesive layer of the separator is in direct contact with the positive electrode plate and/or the negative electrode plate.

In the present disclosure, a change rate of an adhesive strength between the adhesive layer of the separator and the positive and negative electrodes during the first 100 battery cycles (including the 100^{th} cycle) is within 10%, that is, when a battery cycle count ≤100 (for example, the battery cycle count is 1, 5, 10, 50, or 100), the change rate of the adhesive strength between the adhesive layer and the positive electrode plate or the negative electrode plate is within 10%.

### <Non-Aqueous Electrolyte Solution>

In the present disclosure, a mass of ethyl propionate in the non-aqueous electrolyte solution is 5 wt. % to 60 wt. % of a total mass of the non-aqueous electrolyte solution, that is, the mass percentage of ethyl propionate in the non-aqueous electrolyte solution ranges from 5 wt. % to 60 wt. %, with an example of 5 wt. %, 6 wt. %, 10 wt. %, 12 wt. %, 15 wt. %, 20 wt. %, 22 wt. %, 23 wt. %, 25 wt. %, 30 wt. %, 34 wt. %, 35 wt. %, 38 wt. %, 40 wt. %, 48 wt. %, 50 wt. %, 55 wt. %, 60 wt. %, or any point value within a range consisting of any two of the above values.

In one example, the mass percentage of ethyl propionate in the non-aqueous electrolyte solution ranges from 10 wt. % to 40 wt. %.

In the present disclosure, the mass percentage of ethyl propionate in the non-aqueous electrolyte solution represents a percentage by mass of ethyl propionate with respect to the total mass of the non-aqueous electrolyte solution.

The non-aqueous electrolyte solution further includes a first additive. The first additive is selected from at least one of tris(trimethylsilyl) phosphite, tris(trimethylsilyl) borate, lithium bis(trifluoromethanesulphonyl)imide, lithium bis(fluorosulfonyl)imide, 1-propene 1,3-sultone, ethylene sulphite, ethylene sulfate, vinylene carbonate, lithium bis(oxalate)borate, lithium difluorobis(oxalato)phosphate, or vinyl ethylene carbonate.

In one example, the first additive is at least one of tris(trimethylsilyl) phosphite, tris(trimethylsilyl) borate, lithium bis(trifluoromethanesulphonyl)imide, lithium bis(fluorosulfonyl)imide, 1-propene 1,3-sultone, ethylene sulphite, ethylene sulfate, vinylene carbonate, lithium bis(oxalate)borate, lithium difluorobis(oxalato)phosphate, or vinyl ethylene carbonate.

A mass percentage of the first additive in the non-aqueous electrolyte solution ranges from 0 wt. % to 10 wt. %, with an example of 0 wt. %, 1 wt. %, 2 wt. %, 5 wt. %, 8 wt. %, 10 wt. %, or any point value within a range consisting of any two of the above values.

The non-aqueous organic solvent further includes at least one of ethylene carbonate (EC), propylene carbonate (PC), dimethyl carbonate, diethyl carbonate, ethyl methyl carbonate, propyl propionate (PP), or propyl acetate.

In one example, the non-aqueous organic solvent includes ethylene carbonate (EC), propylene carbonate (PC), and propyl propionate (PP).

In one example, a mass ratio of ethylene carbonate (EC), propylene carbonate (PC), and propyl propionate (PP) in the non-aqueous organic solvent is (1-2):1:2, for example, 1.5:1:2.

In one example, the mass ratio of ethylene carbonate (EC), propylene carbonate (PC), and propyl propionate (PP) in the non-aqueous organic solvent is 2:(1-2):2, for example, 2:1.5:2.

The non-aqueous electrolyte solution further includes a lithium salt.

The lithium salt is selected from at least one of lithium bis(trifluoromethanesulfonyl)imide, lithium bis(fluorosulfonyl)imide, or lithium hexafluorophosphate (LiPF₆).

In one example, the lithium salt includes lithium hexafluorophosphate (LiPF₆).

In one example, the lithium salt is lithium hexafluorophosphate (LiPF₆).

A mass percentage of the lithium salt in the non-aqueous electrolyte solution ranges from 13 wt. % to 20 wt. %, with an example of 13 wt. %, 14 wt. %, 15 wt. %, 16 wt. %, 17 wt. %, 18 wt. %, 19 wt. %, 20 wt. %, or any point value within a range consisting of any two of the above values.

In one example, the non-aqueous electrolyte solution further includes a second additive.

The second additive includes at least one of 1,3-propane sultone, lithium difluoro(oxalato)borate, fluoroethylene carbonate, vinylethylene carbonate, or lithium difluorophosphate.

In one example, the second additive includes 1,3-propane sultone and lithium difluoro(oxalato)borate.

In one example, the second additive includes fluoroethylene carbonate, vinylethylene carbonate, and lithium difluorophosphate.

A mass percentage of 1,3-propane sultone in the non-aqueous electrolyte solution ranges from 0.5 wt. % to 5 wt. %, with an example of 0.5 wt. %, 1 wt. %, 2 wt. %, 3 wt. %, 3.5 wt. %, 4 wt. %, 4.5 wt. %, 5 wt. %, or any point value within a range consisting of any two of the above values.

In one example, the mass percentage of 1,3-propane sultone in the non-aqueous electrolyte solution ranges from 2 wt. % to 4 wt. %.

A mass percentage of lithium difluoro(oxalato)borate in the non-aqueous electrolyte solution ranges from 0.01 wt. % to 2 wt. %, with an example of 0.01 wt. %, 0.02 wt. %, 0.05 wt. %, 0.1 wt. %, 0.2 wt. %, 0.5 wt. %, 1 wt. %, 2 wt. %, or any point value within a range consisting of any two of the above values.

A mass percentage of fluoroethylene carbonate in the non-aqueous electrolyte solution ranges from 6 wt. % to 25 wt. %, with an example of 6 wt. %, 10 wt. %, 15 wt. %, 18 wt. %, 20 wt. %, 25 wt. %, or any point value within a range consisting of any two of the above values.

In one example, the mass percentage of fluoroethylene carbonate in the non-aqueous electrolyte solution ranges from 6 wt. % to 18 wt. %.

A mass percentage of vinylethylene carbonate in the non-aqueous electrolyte solution ranges from 0.01 wt. % to 2 wt. %, with an example of 0.01 wt. %, 0.02 wt. %, 0.03 wt. %, 0.05 wt. %, 0.1 wt. %, 0.5 wt. %, 1 wt. %, 2 wt. %, or any point value within a range consisting of any two of the above values.

A mass percentage of lithium difluorophosphate in the non-aqueous electrolyte solution ranges from 0.01 wt. % to 2 wt. %, with an example of 0.01 wt. %, 0.02 wt. %, 0.03 wt. %, 0.05 wt. %, 0.1 wt. %, 0.5 wt. %, 1 wt. %, 2 wt. %, or any point value within a range consisting of any two of the above values.

The first additive and the second additive used in the present disclosure may be both prepared by using a method known in the art, or may be purchased commercially and then obtained.

### <Positive Electrode Plate>

The positive electrode plate includes a positive electrode current collector and a positive electrode active material layer coated on a surface of either or both sides of the positive electrode current collector. The positive electrode active material layer includes a positive electrode active material, a positive electrode conductive agent, and a positive electrode binder.

With respect to a total weight of the positive electrode active material layer, a content of the positive electrode active material may range from 90 wt. % to 99 wt. % (for example, 90 wt. %, 91 wt. %, 92 wt. %, 93 wt. %, 94 wt. %, 95 wt. %, 96 wt. %, 97 wt. %, 98 wt. %, or 99 wt. %), a content of the positive electrode conductive agent may range from 0.5 wt. % to 5 wt. % (for example, 5 wt. %, 4.5 wt. %, 4 wt. %, 3.5 wt. %, 3 wt. %, 2.5 wt. %, 2 wt. %, 1.5 wt. %, 1 wt. %, or 0.5 wt. %), and a content of the positive electrode binder may range from 0.5 wt. % to 5 wt. % (for example, 5 wt. %, 4.5 wt. %, 4 wt. %, 3.5 wt. %, 3 wt. %, 2.5 wt. %, 2 wt. %, 1.5 wt. %, 1 wt. %, or 0.5 wt. %).

In one example, a mass ratio of the positive electrode active material, the positive electrode conductive agent, and the positive electrode binder is 98:1:1.

In one example, the mass ratio of the positive electrode active material, the positive electrode conductive agent, and the positive electrode binder is 97.6:1.4:1.

In one example, the mass ratio of the positive electrode active material, the positive electrode conductive agent, and the positive electrode binder is 97:1:2.

The positive electrode active material is selected from lithium cobalt oxide (LiCoO₂) or lithium cobalt oxide (LiCoO₂) doped and coated with two or more elements among Al, Mg, Mn, Cr, Ti, and Zr, where a chemical formula of the lithium cobalt oxide doped and coated with the two or more elements among Mg, Mn, Cr, Ti, and Zr is LiₓCo_{1-y1-y2-y3-y4}A_{y1}B_{y2}C_{y3}D_{y4}O₂, 0.95≤x≤1.05, 0.01≤y1≤0.1, 0.01≤y2≤0.1, 0≤y3≤0.1, 0≤y4≤0.1, A, B, C, and D being selected from the two or more elements among Al, Mg, Mn, Cr, Ti, and Zr.

The positive electrode conductive agent may be selected from acetylene black.

The positive electrode binder may be selected from polyvinylidene fluoride (PVDF).

### <Negative Electrode Plate>

The negative electrode plate includes a negative electrode current collector and a negative electrode active material layer coated on a surface of either or both sides of the negative electrode current collector. The negative electrode active material layer includes a negative electrode active material, a negative electrode conductive agent, and a negative electrode binder.

The negative electrode active material may be selected from graphite.

The negative electrode active material further optionally contains SiOₓ/C or Si/C, where 0<x<2. For example, the negative electrode active material further contains 1 wt. % to 15 wt. % SiOₓ/C or Si/C, with an example of 1 wt. %, 2 wt. %, 5 wt. %, 8 wt. %, 10 wt. %, 12 wt. %, 15 wt. %, or any point value within a range consisting of any two of the above values.

The negative electrode conductive agent may be selected from at least one of a single-walled carbon nanotube (SWCNT) or a conductive carbon black (SP).

The negative electrode binder may be selected from at least one of a sodium carboxymethyl cellulose (CMC-Na) or styrene-butadiene rubber (SBR).

### <Battery>

The battery may be a lithium-ion battery.

The mass percentage of ethyl propionate in the non-aqueous electrolyte solution is A_{EP}%; a contact area between the separator and the negative electrode plate is Sₙ (measured in m²), and a battery capacity is C (measured in Ah), where A_{EP}, Sₙ, and C are required to satisfy the following relationship: 0.5≤A_{EP}/(Sₙ/C)≤60.

It should be noted that according to a discharge test of JS-150D, under a condition of 25° C., the battery is charged to 4.45 V at 0.7 C, with a cut-off current of 0.025 C, and is discharged to 3.0 V at 0.2 C, so as to obtain the battery capacity C, measured in ampere-hour (briefly expressed as Ah, 1 Ah=3600 C).

In one example, A_{EP}, Sₙ, and C are required to satisfy the following relationship: 2≤A_{EP}/(Sₙ/C)≤40.

The battery capacity C ranges from 0.1 Ah to 100 Ah, with an example of 0.1 Ah, 0.5 Ah, 1 Ah, 5 Ah, 10 Ah, 20 Ah, 50 Ah, 80 Ah, 100 Ah, or any point value within a range consisting of any two of the above values.

The contact area Sₙ between the separator and the negative electrode ranges from 0.0001 m² to 10 m², with an example of 0.0001 m², 0.0005 m², 0.001 m², 0.005 m², 0.01 m², 0.05 m², 0.1 m², 0.5 m², 1 m², 2 m², 5 m², 8 m², 10 m², or any point value within a range consisting of any two of the above values.

In one example, the contact area Sₙ between the separator and the negative electrode is the same as an area of the negative electrode plate, that is, Sₙ=the area of the negative electrode plate.

In one example, a charge cut-off voltage of the battery is 4.45 V or above.

Beneficial effects of the present disclosure are as follows.

Firstly, the present disclosure provides a battery. The battery prepared by rationally designing the relationship between the mass percentage A_{EP} of ethyl propionate in the non-aqueous electrolyte solution, the contact area Sₙ between the separator and the negative electrode, and the battery capacity C to satisfy 0.5≤A_{EP}/(Sₙ/C)≤60 can not only effectively improve the battery cycle life and reduce expansion during battery cycling, but can also take into account the low-temperature performance of the battery.

Secondly, the battery in the present disclosure includes the positive electrode plate, the negative electrode plate, the separator disposed between the positive electrode plate and the negative electrode plate, and the non-aqueous electrolyte solution. The ratio of the mass percentage of ethyl propionate in the non-aqueous electrolyte solution to the mass percentage of HFP in the copolymer of hexafluoropropylene-vinylidene fluoride is controlled to be between 0.2 and 60, and the contact area between the separator and the negative electrode is set to be from 0.0001 m² to 10 m², to achieve a battery capacity of 0.1 Ah to 100 Ah, thereby ensuring that the change rate of the adhesive strength between the adhesive layer of the separator and the positive and negative electrodes during the first 100 cycles of the battery is within 10%, and making the positive and negative electrodes of the battery have a better interface to reduce expansion during cycling, thereby improving the battery cycle life. In addition, ethyl propionate may also reduce a viscosity of the solvent to improve the electrolyte solution wettability and ionic conductivity, thereby improving the low-temperature performance of the battery.

Thirdly, the present disclosure provides a battery. The battery prepared through a synergistic effect of the separator and the non-aqueous electrolyte solution and the combination of the positive and negative electrode materials can not only effectively improve the battery cycle life, but can also effectively reduce expansion during battery cycling.

Fourthly, the battery in the present disclosure includes the positive electrode plate, the negative electrode plate, the separator disposed between the positive electrode plate and the negative electrode plate, and the non-aqueous electrolyte solution. The ratio of the mass percentage of ethyl propionate in the non-aqueous electrolyte solution to the mass percentage of HFP in the copolymer of hexafluoropropylene-vinylidene fluoride is controlled to be between 0.2 and 60, where an ethyl propionate non-aqueous organic solvent has a strong swelling effect on PVDF in the separator; and a synergistic effect of the ethyl propionate non-aqueous organic solvent and HFP may enhance the swelling effect of the separator. Based on this, by controlling a content ratio of ethyl propionate and HFP, the present disclosure may not only improve the adhesive strength between the separator and the positive and negative electrode plates, ensuring that the change rate of the adhesive strength between the adhesive layer of the separator and the positive and negative electrodes during the first 100 battery cycles (including the 100^{th} cycle) is within 10%, but can also make the positive and negative electrodes of the battery have a better interface to reduce expansion during cycling, thereby reducing the damage and reconstruction of a CEI film, and improving the stability of the positive electrode material at a high temperature and a high voltage.

Fifthly, the present disclosure provides a battery. The battery prepared through a synergistic effect of the separator and the electrolyte solution and the combination of positive and negative electrode materials can not only effectively improve the battery cycle life and reduce expansion during battery cycling, but can also take into account the low-temperature performance of the battery.

Sixthly, the battery in the present disclosure includes the positive electrode plate, the negative electrode plate, the separator disposed between the positive electrode plate and the negative electrode plate, and the non-aqueous electrolyte solution. The ratio of the percentage by mass of ethyl propionate in the non-aqueous electrolyte solution to the mass percentage of HFP in the copolymer of hexafluoropropylene-vinylidene fluoride is controlled to be between 0.2 and 60, where a non-aqueous organic solvent including ethyl propionate has a strong swelling effect on PVDF in the separator; and a synergistic effect of the non-aqueous organic solvent including ethyl propionate and HFP may enhance the swelling effect of the separator. Based on this, by controlling a content ratio of ethyl propionate and HFP, the present disclosure may not only improve the adhesive strength between the separator and the positive electrode plate or the negative electrode plate, ensuring that the change rate of the adhesive strength between the adhesive layer of the separator and the positive electrode plate or the negative electrode during the first 100 battery cycles is within 10%, but can also make the positive and negative electrodes of the battery have a better interface to reduce expansion during cycling, thereby reducing the damage and reconstruction of a CEI film, and improving the stability of the positive electrode material at a high temperature and a high voltage. In addition, ethyl propionate may also reduce a viscosity of the solvent to improve the electrolyte solution wettability and ionic conductivity, thereby improving the low-temperature performance of the battery. Moreover, a synergistic effect between the additives in the electrolyte solution formula further enables the battery to take into account a long cycle life and low-temperature performance. Fluoroethylene carbonate and vinylethylene carbonate can form a thick and stable composite SEI protective film on a surface of the negative electrode, to prevent the electrolyte solution from being reduced and decomposed on the surface of the negative electrode, thereby not only reducing heat generated by side reactions and reducing expansion during cycling, but also improving the battery cycle life. In addition, lithium difluorophosphate can also form an SEI film rich in inorganic components on the positive and negative electrodes to reduce impedance of the film, thereby improving the low-temperature performance of the battery.

Lastly, the battery in the present disclosure includes the positive electrode plate, the negative electrode plate, the separator disposed between the positive electrode plate and the negative electrode plate, and the non-aqueous electrolyte solution. The ratio of the mass percentage of ethyl propionate in the non-aqueous electrolyte solution to the mass percentage of HFP in the copolymer of hexafluoropropylene-vinylidene fluoride is controlled to be between 0.2 and 60, where an ethyl propionate non-aqueous organic solvent has a strong swelling effect on PVDF in the separator; and a synergistic effect of the ethyl propionate non-aqueous organic solvent and HFP may enhance the swelling effect of the separator. Based on this, by controlling a content ratio of ethyl propionate and HFP, the present disclosure may not only improve the adhesive strength between the separator and the positive and negative electrode plates, ensuring that the change rate of the adhesive strength between the adhesive layer of the separator and the positive and negative electrode plates during the first 100 battery cycles is within 10%, but can also make the positive and negative electrodes of the battery have a better interface to reduce expansion during cycling, thereby reducing the damage and reconstruction of a CEI film, and improving the stability of the positive electrode material at a high temperature and a high voltage. In addition, ethyl propionate can may reduce a viscosity of the solvent to improve the electrolyte solution wettability and ionic conductivity, thereby improving the low-temperature performance of the battery. Moreover, a synergistic effect between the additives in the electrolyte solution formula further ensures a long cycle life of the battery. The 1,3-propane sultone and lithium difluoro(oxalato)borate additives can form a firm and stable composite SEI protective film on a surface of the positive and negative electrodes, to prevent the electrolyte solution from being oxidized and reduced and decomposed on the surface of the positive and negative electrodes, thereby not only reducing heat generated by side reactions and reducing expansion during cycling, but also improving the battery cycle life.

### DETAILED DESCRIPTION OF THE EMBODIMENTS

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

Experimental methods used in the following examples are conventional methods, unless otherwise specified. Reagents, materials, etc. used in the following examples are all commercially available, unless otherwise specified.

### GROUP A OF EXAMPLES AND COMPARATIVE EXAMPLES

### Comparative Examples A1-A3 and Examples A1-A8

Lithium-ion batteries in Comparative examples A1-A3 and Examples A1-A8 were all prepared according to the following preparation method, and a difference lies only in that different separators and electrolyte solutions were selected. The difference is specifically shown in Table A1.

### (1) Preparation of a Positive Electrode Plate

A positive electrode active material LiCoO₂, a binder polyvinylidene fluoride (PVDF), and a conductive agent acetylene black were mixed at a weight ratio of 97:1:2, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 10 μm. The coated aluminum foil was baked in a five-stage oven with different temperatures and then dried in an oven at 120° C. for 8 hours, followed by rolling and cutting, to obtain the required positive electrode plate.

### (2) Preparation of a Negative Electrode Plate

A negative electrode material artificial graphite with a mass percentage of 96%, a conductive agent single-walled carbon nanotube (SWCNT) with a mass percentage of 0.2%, a conductive agent conductive carbon black (SP) with a mass percentage of 1%, a binder sodium carboxymethyl cellulose (CMC-Na) with a mass percentage of 1%, and a binder styrene-butadiene rubber (SBR) with a mass percentage of 1.8% were made into a slurry by using a wet process. The slurry was applied on a surface of a negative electrode current collector with copper foil, and then drying (temperature: 85° C., time: 5 hours), rolling, and die cutting were carried out to obtain the negative electrode plate.

### (3) Preparation of a Non-Aqueous Electrolyte Solution

In a glove box filled with argon (moisture <10 ppm, oxygen <1 ppm), ethylene carbonate (EC), propylene carbonate (PC), and propyl propionate (PP) were evenly mixed at a mass ratio of 2:1.5:2, and LiPF₆ accounting for 14 wt. % of a total mass of the non-aqueous electrolyte solution and ethyl propionate (specific amounts of ethyl propionate are shown in Table A1) accounting for 5 wt. % to 60 wt. % of the total mass of the non-aqueous electrolyte solution were slowly added into the mixed solution. The mixture was stirred evenly to obtain the non-aqueous electrolyte solution.

### (4) Preparation of a Separator

An alumina ceramic layer with a thickness of 2 μm was applied on each of two sides of a polyethylene substrate with a thickness of 5 μm (the alumina ceramic layer was obtained by mixing 91% aluminum oxide, 4% methyl methacrylate, 2% polyvinylpyrrolidone, 2.5% sodium carboxymethyl cellulose, and 0.5% polysiloxane quaternary ammonium salt and then applying the mixture by using a gravure roller), and then a copolymer of polyvinylidene fluoride-hexafluoropropylene (PVDF-HFP) and DMAC (dimethylacetamide, which is used to dissolve PVDF) were mixed with a solid content of 6% (a ratio of PVDF-HFP and DMAC is 6:94) and stirred for 120 minutes at a stirring speed of 1,500 rpm to obtain a slurry L. The slurry L was evenly applied on the surface of the alumina ceramic, and after being watered and dried, a 1 μm adhesive layer on each of the two sides was obtained.

### (5) Preparation of a Lithium-Ion Battery

The prepared positive electrode plate, separator, and negative electrode plate were wound to obtain an unfilled bare cell. The bare cell was placed in outer packaging foil, and the prepared non-aqueous electrolyte solution was injected into the dried bare cell. After processes such as vacuum packaging, standing, forming, shaping, and sorting, the lithium-ion battery required was obtained.

TABLE A1
Lithium-ion batteries prepared in Comparative examples A1-A3 and Examples A1-A8

| | | | Contact area, | | | | Ratio of |
|---|---|---|---|---|---|---|---|
| | | Mass percentage | Sₙ (m²), | | | | A_{EP} to the |
| | | (wt. %) of HFP in | between the | | Mass | | mass |
| Comparative | PVDF | the PVDF-HFP of | separator and | Battery | percentage, | | percentage |
| example/ | molecular | the adhesive layer | the negative | capacity, | A_{EP}, of ethyl | A_{EP}/ | of HFP in |
| Example | weight | of the separator | electrode | C (Ah) | propionate | (Sₙ/C) | the PVDF-HFP |
| Comparative | 500,000 | 2.00 | 0.1 | 2 | 0.00% | / | / |
| example A1 | | | | | | | |
| Comparative | 500,000 | 2.00 | 0.1 | 2 | 0.2% | 0.04 | 0.1 |
| example A2 | | | | | | | |
| Comparative | 500,000 | 1.00 | 0.1 | 2 | 80% | 16 | 80 |
| example A3 | | | | | | | |
| Example A1 | 700,000 | 2.50 | 0.1 | 2 | 20.00% | 4 | 8.00 |
| Example A2 | 800,000 | 3.00 | 0.15 | 2 | 30.00% | 4 | 10.00 |
| Example A3 | 1,000,000 | 5.00 | 0.05 | 2 | 10.00% | 4 | 2.00 |
| Example A4 | 500,000 | 1.50 | 0.15 | 6 | 60.00% | 24 | 40.00 |
| Example A5 | 800,000 | 6.50 | 0.48 | 6 | 40.00% | 5 | 6.15 |
| Example A6 | 600,000 | 3.50 | 0.8 | 10 | 50.00% | 6.25 | 14.29 |
| Example A7 | 800,000 | 20.00 | 6 | 75 | 5.00% | 0.625 | 0.25 |
| Example A8 | 800,000 | 9.00 | 4 | 50 | 20.0% | 2.5 | 2.22 |

The batteries obtained in the above comparative examples and examples were tested for electrochemical performance. The related descriptions are as follows:

25° C. cycling test: The batteries obtained in the above examples and comparative examples were placed in an environment of (25±2°) C to stand for 2 to 3 hours. When the battery bodies reached (25±2°) C, the batteries were charged at a constant current of 1 C, with a cut-off current of 0.05 C. After the batteries were fully charged, the batteries were left aside for 5 minutes, and then discharged at a constant current of 1 C to a cut-off voltage of 3.0 V. A highest discharge capacity for the first three cycles was recorded as an initial capacity Q. When the number of cycles reaches 1,000, the last discharge capacity of the battery was recorded as Q₁. An initial thickness T of the cell was recorded. A thickness after 1,000 cycles was recorded as T₁. The recorded results are shown in Table A2.

Formulas used are as follows: Capacity retention rate (%)=Q₁/Q×100%; and Thickness change rate (%)=(T₁−T)/T×100%.

Low temperature discharge test: The batteries obtained in the above examples and comparative examples were first discharged at 0.2 C to 3.0 V at an ambient temperature of (25±3°) C, and left aside for 5 minutes. The batteries were charged at 0.7 C, and when a voltage at the battery terminals reached a charging limit voltage, the batteries began to be charged at a constant voltage. The charging was not stopped until a charging current is less than or equal to a cut-off current. The batteries were left aside for 5 minutes and then discharged at 0.2 C to 3.0 V, and a discharge capacity in this case was recorded as a room-temperature capacity Q₄. Then the batteries were charged at 0.7 C, and when a voltage at the battery terminals reached the charging limit voltage, the batteries began to be charged at a constant voltage. The charging was not stopped until a charging current is less than or equal to a cut-off current. The fully charged batteries were left aside at (−20±2°) C for 4 hours, and then discharged at 0.25 C to a cut-off voltage 3.0 V. A discharge capacity Q₅ was recorded to calculate a low-temperature discharge capacity retention rate. The recorded results are shown in Table A2.

A formula used is as follows: Low-temperature discharge capacity retention rate (%)=Q₅/Q₄×100%.

Method for measuring an adhesive strength between the adhesive layer of the separator and the negative electrode:

The batteries obtained in the above examples and comparative examples were placed in an environment of (25±2°) C to stand for 2 to 3 hours. When the battery bodies reached (25±2°) C, the batteries were charged at a constant current of 0.7 C, with a cut-off current of 0.05 C. When a voltage at the battery terminals reached the charging limit voltage, the batteries began to be charged at a constant voltage. The charging was not stopped until a charging current is less than or equal to a cut-off current. The batteries were left aside for 5 minutes, and the fully charged batteries are dissected. An overall sample of the separator and the negative electrode with a length of 30 mm*a width of 15 mm was selected along a tab direction. The separator and the negative electrode at an included angle of 180 degrees were tested on a universal testing machine at a speed of 100 mm/min and a test displacement of 50 mm. Test results are recorded as an adhesive strength N (measured in N/m) between the separator and the negative electrode, an adhesive strength N1 (measured in N/m) tested on fresh batteries (which have not been cycled after the completion of preparation), and an adhesive strength N2 (measured in N/m) tested on the batteries after 100 cycles.

A formula used is as follows:

Change rate (%) of the adhesive strength between the adhesive layer of the separator and the negative electrode=(N1−N2)/N1×100%.

TABLE A2
Experimental test results of the batteries obtained
in Comparative examples A1-A3 and Examples A1-A8

| | | | | Change rate of the |
|---|---|---|---|---|
| | | | | adhesive strength |
| | | | | between the adhesive |
| | | | | layer of the separator |
| Comparative | 1,000 cycles at 1 C and 25° C. | | Discharge capacity | and the negative |
| example/ | Capacity retention | Thickness change | retention rate at 0.25 C | electrode after 100 |
| Example | rate | rate | and −20° C. | cycles at 25° C. |
| Comparative | 0.00% | 65.45% | 52.39% | 68.12% |
| example A1 | | | | |
| Comparative | 0.00% | 58.73% | 60.23% | 64.96% |
| example A2 | | | | |
| Comparative | 0.00% | 72.73% | 73.24% | 75.43% |
| example A3 | | | | |
| Example A1 | 70.66% | 9.30% | 62.31% | 8.04% |
| Example A2 | 70.97% | 9.40% | 64.04% | 8.99% |
| Example A3 | 70.35% | 9.50% | 60.35% | 9.08% |
| Example A4 | 75.66% | 8.60% | 70.30% | 8.23% |
| Example A5 | 71.22% | 9.00% | 65.32% | 8.62% |
| Example A6 | 76.43% | 8.30% | 67.98% | 7.88% |
| Example A7 | 69.42% | 11.25% | 62.74% | 9.52% |
| Example A8 | 73.24% | 8.82% | 63.42% | 8.11% |

It can be seen from the results in Table A2 that the battery prepared in the present disclosure through a synergistic effect of the separator and the electrolyte solution and the combination of positive and negative electrode materials can not only effectively improve the battery cycle life and reduce expansion during battery cycling, but can also take into account the low-temperature performance of the battery.

### GROUP B OF EXAMPLES AND COMPARATIVE EXAMPLES

### Comparative Examples B1-1B2 and Examples B1-1B8

Lithium-ion batteries in Comparative examples B31-1B2 and Examples B31-1B8 were all prepared according to the following preparation method, and a difference lies only in that different separators and non-aqueous electrolyte solutions were selected. The difference is specifically shown in Table B1.

### (1) Preparation of a Positive Electrode Plate

The preparation is performed with reference to the preparation method in the group A of examples and comparative examples, except that LiCoO₂, PVDF, and acetylene black are mixed at a weight ratio of 98:1:1.

### (2) Preparation of a Negative Electrode Plate

A negative electrode material artificial graphite with a mass percentage of 97%, a conductive agent single-walled carbon nanotube (SWCNT) with a mass percentage of 0.1%, a conductive agent conductive carbon black (SP) with a mass percentage of 0.8%, a binder sodium carboxymethyl cellulose (CMC-Na) with a mass percentage of 1%, and a binder styrene-butadiene rubber (SBR) with a mass percentage of 1.1% were made into a slurry by using a wet process. The slurry was applied on a surface of a negative electrode current collector with 6 μm thick copper foil, and then drying (temperature: 85° C., time: 5 hours), rolling, and die cutting were carried out to obtain the negative electrode plate.

### (3) Preparation of a Non-Aqueous Electrolyte Solution

The preparation is performed with reference to the preparation method in the group A of examples and comparative examples, and specific amounts of ethyl propionate are shown in Table B1.

### (4) Preparation of a Separator

The preparation is performed with reference to the preparation method in the group A of examples and comparative examples, where for details of the mass percentage of hexafluoropropylene (HFP) and the molecular weight of polyvinylidene fluoride (PVDF) in the copolymer of polyvinylidene fluoride-hexafluoropropylene, refer to Table B1.

### (5) Preparation of a Lithium-Ion Battery

The preparation is performed with reference to the preparation method in the group A of examples and comparative examples.

TABLE B1
Lithium-ion batteries prepared in Comparative examples B1-B2 and Examples B1-B8

| | Mass percentage (wt. %) of | | | Ratio of the mass percentage of ethyl |
|---|---|---|---|---|
| | hexafluoropropylene in the | | Added | propionate in the non-aqueous |
| | binder polyvinylidene | Molecular | amount | electrolyte solution to the mass |
| Comparative | fluoride-hexafluoropropylene | weight | (wt. %) of | percentage of hexafluoropropylene in |
| example/ | copolymer of the adhesive | (Da) of | ethyl | the copolymer of polyvinylidene |
| Example | layer of the separator | PVDF | propionate | fluoride-hexafluoropropylene |
| Comparative | 0.00 | 500,000 | 0.00 | / |
| example B1 | | | | |
| Comparative | 2.00 | 500,000 | 0.00 | / |
| example B2 | | | | |
| Example B1 | 2.50 | 700,000 | 23.00 | 9.2 |
| Example B2 | 3.00 | 800,000 | 34.00 | 11.3 |
| Example B3 | 5.00 | 1,000,000 | 12.00 | 2.4 |
| Example B4 | 1.50 | 500,000 | 55.00 | 36.7 |
| Example B5 | 6.50 | 800,000 | 38.00 | 5.8 |
| Example B6 | 3.50 | 600,000 | 48.00 | 13.7 |
| Example B7 | 23.00 | 800,000 | 6.00 | 0.26 |
| Example B8 | 9.00 | 800,000 | 22.00 | 2.4 |

The batteries obtained in the above comparative examples and examples were tested for electrochemical performance. The related descriptions are as follows:

25° C. cycling test: For details, refer to the test method in the group A of examples and comparative examples. The recorded results are shown in Table B2.

Method for measuring an adhesive strength between the adhesive layer of the separator and the negative electrode: For details, refer to the test method in the group A of examples and comparative examples. The recorded results are shown in Table B2.

TABLE B2
Experimental test results of the batteries obtained
in Comparative examples B1-B2 and Examples B1-B8

| | | | Change rate (%) of the adhesive strength |
|---|---|---|---|
| Comparative | 1,000 cycles at 1 C and 25° C. | | between the adhesive layer of the |
| example/ | Capacity retention | Thickness change | separator and the negative electrode |
| Example | rate (%) | rate (%) | after 100 cycles at 25° C. |
| Comparative | 0.00 | 66.00 | 70.50 |
| example B1 | | | |
| Comparative | 30.20 | 32.30 | 45.60 |
| example B2 | | | |
| Example B1 | 71.23 | 10.30 | 9.20 |
| Example B2 | 74.08 | 9.40 | 8.40 |
| Example B3 | 73.29 | 9.50 | 9.00 |
| Example B4 | 75.66 | 8.60 | 8.50 |
| Example B5 | 77.02 | 8.20 | 8.80 |
| Example B6 | 72.43 | 10.50 | 9.30 |
| Example B7 | 71.20 | 11.20 | 7.60 |
| Example B8 | 72.69 | 9.70 | 8.10 |

It can be seen from the results in Table B2 that the lithium-ion battery prepared in the present disclosure through a synergistic effect of the separator and the non-aqueous electrolyte solution and the combination of the positive and negative electrode materials can not only effectively improve the battery cycle life, but can also reduce expansion during battery cycling.

### GROUP C OF EXAMPLES AND COMPARATIVE EXAMPLES

### Comparative Example C1 and Examples C1-C13

Lithium-ion batteries in Comparative example C1 and Examples C1-C13 were all prepared according to the following preparation method, and a difference lies only in that different separators and electrolyte solutions were selected. The difference is specifically shown in Table C1.

### (1) Preparation of a Positive Electrode Plate

The preparation is performed with reference to the preparation method in the group A of examples and comparative examples, except that LiCoO₂, PVDF, and acetylene black are mixed at a weight ratio of 97.6:1.4:1.

### (2) Preparation of a Negative Electrode Plate

A negative electrode material artificial graphite with a mass percentage of 96.9%, a conductive agent single-walled carbon nanotube (SWCNT) with a mass percentage of 0.1%, a conductive agent conductive carbon black (SP) with a mass percentage of 0.8%, a binder sodium carboxymethyl cellulose (CMC-Na) with a mass percentage of 0.9%, and a binder styrene-butadiene rubber (SBR) with a mass percentage of 1.3% were made into a slurry by using a wet process. The slurry was applied on a surface of a negative electrode current collector with copper foil, and then drying (temperature: 85° C., time: 5 hours), rolling, and die cutting were carried out to obtain the negative electrode plate.

### (3) Preparation of a Non-Aqueous Electrolyte Solution

The preparation is performed with reference to the preparation method in the group A of examples and comparative examples, except that EC, PC, and PP are evenly mixed at a mass ratio of 1.5:1:2, and specific amounts of ethyl propionate and additives are shown in Table C1.

### (4) Preparation of a Separator

The preparation is performed with reference to the preparation method in the group A of examples and comparative examples, where for details of the mass percentage of hexafluoropropylene ((FP) and the molecular weight of polyvinylidene fluoride (PVDF) in the copolymer of polyvinylidene fluoride-hexafluoropropylene, refer to Table Cv.

### (5) Preparation of a Lithium-Ion Battery

The preparation is performed with reference to the preparation method in the group A of examples and comparative examples.

TABLE C1
Lithium-ion batteries prepared in Comparative examples C1-C3 and Examples C1-C11

| | Mass percentage (wt. %) | | Mass percentage | Mass percentage | |
|---|---|---|---|---|---|
| Comparative | of HFP in the PVDF- | Mass percentage | (wt. %) of | (wt. %) of | Mass percentage |
| example/ | HFP of the adhesive | (wt. %) of ethyl | fluoroethylene | vinylethylene | (wt. %) of lithium |
| Example | layer of the separator | propionate | carbonate | carbonate | difluorophosphate |
| Comparative | 0.0 | 20.0 | 8.0 | 0.5 | 0.5 |
| example C1 | | | | | |
| Comparative | 5.0 | 0.0 | 8.0 | 0.5 | 0.5 |
| example C2 | | | | | |
| Comparative | 0.5 | 40.0 | 8.0 | 0.5 | 0.5 |
| example C3 | | | | | |
| Example C1 | 5.0 | 20.0 | 8.0 | 0.5 | 0.5 |
| Example C2 | 3.0 | 10.0 | 6.0 | 0.3 | 0.2 |
| Example C3 | 6.0 | 15.0 | 15.0 | 0.4 | 0.3 |
| Example C4 | 8.0 | 30.0 | 10.0 | 0.2 | 1.0 |
| Example C5 | 1.0 | 60.0 | 9.0 | 2.0 | 0.01 |
| Example C6 | 4.0 | 40.0 | 8.0 | 0.5 | 0.5 |
| Example C7 | 15.0 | 50.0 | 12.0 | 1.0 | 2.0 |
| Example C8 | 25.0 | 5.0 | 25.0 | 0.01 | 0.4 |
| Example C9 | 5.0 | 20.0 | 0.0 | 0.5 | 0.5 |
| Example C10 | 5.0 | 20.0 | 8.0 | 0.0 | 0.5 |
| Example C11 | 5.0 | 20.0 | 8.0 | 0.5 | 0.0 |

The batteries obtained in the above comparative examples and examples were tested for electrochemical performance. The related descriptions are as follows:

25° C. cycling test: For details, refer to the test method in the group A of examples and comparative examples. The recorded results are shown in Table C2.

10° C. cycling test: The batteries obtained in the above examples and comparative examples were placed in an environment of (10±2°) C to stand for 2 to 3 hours. When the battery bodies reached (10±2°) C, the batteries were charged at a constant current of 0.7 C, with a cut-off current of 0.05 C. After the batteries were fully charged, the batteries were left aside for 5 minutes, and then discharged at a constant current of 0.5 C to a cut-off voltage of 3.0 V. A highest discharge capacity for the first three cycles was recorded as an initial capacity Q₂. When the number of cycles reaches 300, the last discharge capacity of the battery was recorded as Q₃. An initial thickness T₂ of the cell was recorded. A thickness after 300 cycles was recorded as T₃. The recorded results are shown in Table C2.

Formulas used are as follows: Capacity retention rate (%)=Q₃/Q₂×100%; and Thickness change rate (%)=(T₃−T₂)/T₂×100%.

Low temperature discharge test: The batteries obtained in the above examples and comparative examples were first discharged at 0.2 C to 3.0 V at an ambient temperature of (25±3°) C, and left aside for 5 minutes. The batteries were charged at 0.7 C, and when a voltage at the battery terminals reached a charging limit voltage, the batteries began to be charged at a constant voltage. The charging was not stopped until a charging current is less than or equal to a cut-off current. The batteries were left aside for 5 minutes and then discharged at 0.2 C to 3.0 V, and a discharge capacity in this case was recorded as a room-temperature capacity Q₄. Then the batteries were charged at 0.7 C, and when a voltage at the battery terminals reached the charging limit voltage, the batteries began to be charged at a constant voltage. The charging was not stopped until a charging current is less than or equal to a cut-off current. The fully charged batteries were left aside at (−10±2°) C for 4 hours, and then discharged at 0.4 C to a cut-off voltage 3.0 V. A discharge capacity Q₅ was recorded to calculate a low-temperature discharge capacity retention rate. The recorded results are shown in Table C2.

A formula used is as follows: Low-temperature discharge capacity retention rate (%)=Q₅/Q₄×100%.

Thermal shock test at 130° C.: The batteries obtained in the above examples and comparative examples were heated in a convection mode or by using a circulation hot air box at a start temperature of (25±3)° C., with a temperature change rate of a (5±2)° C./min. The temperature was raised to (130±2)° C., the batteries were kept at the temperature for 60 minutes, and then the test ended. The recorded status results of the batteries are shown in Table C2.

Method for measuring an adhesive strength between the adhesive layer of the separator and the negative electrode: For details, refer to the test method in the group A of examples and comparative examples. The recorded results are shown in Table C2.

TABLE C2
Experimental test results of the batteries obtained in Comparative examples C1-C3 and Examples C1-C11

| | | | | | | | | Change rate (%) |
|---|---|---|---|---|---|---|---|---|
| | | | | | | | | of the adhesive |
| | | | | | | | | strength |
| | | | | | | | | between the |
| | | | | | Discharge | Thermal shock for 60 | | adhesive layer |
| | 1,000 cycles at 1 C | | 300 cycles at 0.7 C | | capacity | minutes at 130° C. | | of the separator |
| | and 25° C. | | and 10° C. | | retention | Ignition | Explosion | and the negative |
| Comparative | Capacity | Thickness | Capacity | Thickness | rate (%) | (number of | (number of | electrode after |
| example/ | retention | change | retention | change | at 0.4 C | passed/number | passed/number | 100 cycles at |
| Example | rate (%) | rate (%) | rate (%) | rate (%) | and −10° C. | of tested) | of tested) | 25° C. |
| Comparative | 0.00 | 67.1 | 20.30 | 58.4 | 46.38 | 0/5 | 0/5 | 40.3 |
| example C1 | | | | | | | | |
| Comparative | 25.21 | 26.4 | 23.24 | 48.3 | 40.28 | 3/5 | 3/5 | 34.5 |
| example C2 | | | | | | | | |
| Comparative | 38.45 | 34.3 | 40.65 | 25.5 | 57.28 | 4/5 | 4/5 | 22.1 |
| example C3 | | | | | | | | |
| Example C1 | 72.12 | 9.5 | 80.19 | 12.8 | 62.59 | 5/5 | 5/5 | 8.4 |
| Example C2 | 73.13 | 9.0 | 78.39 | 10.9 | 60.48 | 5/5 | 5/5 | 7.9 |
| Example C3 | 76.45 | 8.8 | 83.27 | 9.4 | 61.87 | 5/5 | 5/5 | 9.2 |
| Example C4 | 75.10 | 8.5 | 85.79 | 8.6 | 67.28 | 5/5 | 5/5 | 8.3 |
| Example C5 | 70.24 | 11.4 | 81.87 | 9.0 | 69.81 | 5/5 | 5/5 | 8.1 |
| Example C6 | 71.9 | 10.6 | 76.83 | 10.3 | 65.73 | 5/5 | 5/5 | 9.3 |
| Example C7 | 78.25 | 9.3 | 77.95 | 9.3 | 66.38 | 5/5 | 5/5 | 7.6 |
| Example C8 | 70.36 | 8.3 | 80.84 | 11.2 | 60.23 | 5/5 | 5/5 | 9.5 |
| Example C9 | 20.54 | 38.2 | 22.51 | 44.0 | 50.75 | 2/5 | 2/5 | 28.6 |
| Example C10 | 56.35 | 23.5 | 48.92 | 28.9 | 52.41 | 0/5 | 0/5 | 24.3 |
| Example C11 | 59.49 | 28.8 | 50.29 | 23.4 | 43.29 | 2/5 | 1/5 | 20.2 |

It can be seen from the results in Table C2 that the battery prepared in the present disclosure through a synergistic effect of the separator and the electrolyte solution and the combination of positive and negative electrode materials can not only effectively improve the battery cycle life and reduce expansion during battery cycling, but can also take into account the low-temperature performance of the battery.

### GROUP D OF EXAMPLES AND COMPARATIVE EXAMPLES

### Comparative Examples D1-D3 and Examples D1-D10

Lithium-ion batteries in Comparative examples D1-D3 and Examples D1-D10 were all prepared according to the following preparation method, and a difference lies only in that different separators and non-aqueous electrolyte solutions were selected. The difference is specifically shown in Table D1.

### (1) Preparation of a Positive Electrode Plate

The preparation is performed with reference to the preparation method in the group A of examples and comparative examples, except that LiCoO₂, PVDF, and acetylene black are mixed at a weight ratio of 98:1:1.

### (2) Preparation of a Negative Electrode Plate

A negative electrode material artificial graphite with a mass percentage of 97%, a conductive agent single-walled carbon nanotube (SWCNT) with a mass percentage of 0.1%, a conductive agent conductive carbon black (SP) with a mass percentage of 0.8%, a binder sodium carboxymethyl cellulose (CMC-Na) with a mass percentage of 1%, and a binder styrene-butadiene rubber (SBR) with a mass percentage of 1.1% were made into a slurry by using a wet process. The slurry was applied on a surface of a negative electrode current collector with copper foil, and then drying (temperature: 85° C., time: 5 hours), rolling, and die cutting were carried out to obtain the negative electrode plate.

### (3) Preparation of a Non-Aqueous Electrolyte Solution

The preparation is performed with reference to the preparation method in the group A of examples and comparative examples, and specific amounts of ethyl propionate and additives are shown in Table D1.

### (4) Preparation of a Separator

The preparation is performed with reference to the preparation method in the group A of examples and comparative examples. For details of the percentage by mass of hexafluoropropylene in the copolymer of polyvinylidene fluoride (PVDF)-hexafluoropropylene (P), refer to Table D1.

### (5) Preparation of a Lithium-Ion Battery

The preparation is performed with reference to the preparation method in the group A of examples and comparative examples.

TABLE D1
Lithium-ion batteries prepared in Comparative examples D1-D3 and Examples D1-D10

| | Mass percentage | | | |
|---|---|---|---|---|
| | (wt. %) of HFP in | Mass percentage | | Mass percentage of |
| Comparative | the PVDF-HFP of | of ethyl | Mass percentage | lithium |
| example/ | the adhesive layer | propionate | of 1,3-propane | difluoro(oxalato)borate |
| Example | of the separator | (wt. %) | sultone (wt. %) | (wt. %) |
| Comparative | 0.0 | 25.0 | 5.0 | 0.5 |
| example D1 | | | | |
| Comparative | 3.0 | 0.0 | 5.0 | 0.5 |
| example D2 | | | | |
| Comparative | 0.5 | 50.0 | 5.0 | 0.5 |
| example D3 | | | | |
| Example D1 | 3.0 | 25.0 | 5.0 | 0.5 |
| Example D2 | 5.0 | 30.0 | 3.0 | 0.8 |
| Example D3 | 8.0 | 15.0 | 2.5 | 1.0 |
| Example D4 | 1.0 | 60.0 | 4.0 | 0.01 |
| Example D5 | 7.0 | 35.0 | 4.5 | 1.5 |
| Example D6 | 4.0 | 50.0 | 3.5 | 0.2 |
| Example D7 | 25.0 | 5.0 | 0.5 | 2.0 |
| Example D8 | 10.0 | 20.0 | 2.0 | 0.40 |
| Example D9 | 3.0 | 25.0 | 0.0 | 0.5 |
| Example D10 | 3.0 | 25.0 | 5.0 | 0.0 |

The batteries obtained in the above comparative examples and examples were tested for electrochemical performance. The related descriptions are as follows:

25° C. cycling test: For details, refer to the test method in the group A of examples and comparative examples. The recorded results are shown in Table D2.

10° C. cycling test: For details, refer to the test method in the group C of examples and comparative examples. The recorded results are shown in Table D2.

Low temperature discharge test: For details, refer to the test method in the group A of examples and comparative examples. The recorded results are shown in Table D2.

Thermal shock test at 130° C.: For details, refer to the test method in the group C of examples and comparative examples. The recorded status results of the batteries are shown in Table D2.

Method for measuring an adhesive strength between the adhesive layer of the separator and the negative electrode: For details, refer to the test method in the group A of examples and comparative examples. The recorded results are shown in Table D2.

TABLE D2
Experimental test results of the batteries obtained in Comparative examples D1-D3 and Examples D1-D10

| | | | | | | | | Change rate (%) |
|---|---|---|---|---|---|---|---|---|
| | | | | | | | | of the adhesive |
| | | | | | | | | strength |
| | | | | | | | | between the |
| | | | | | Discharge | Thermal shock for 60 | | adhesive layer |
| | 1,000 cycles at 1 C | | 300 cycles at 0.7 C | | capacity | minutes at 130° C. | | of the separator |
| | and 25° C. | | and 10° C. | | retention | Ignition | Explosion | and the negative |
| Comparative | Capacity | Thickness | Capacity | Thickness | rate (%) | (number of | (number of | electrode after |
| example/ | retention | change | retention | change | at 0.25 C | passed/number | passed/number | 100 cycles at |
| Example | rate (%) | rate (%) | rate (%) | rate (%) | and −20° C. | of tested) | of tested) | 25° C. |
| Comparative | 0.00 | 57.1 | 23.78 | 55.3 | 53.31 | 0/5 | 0/5 | 60.2 |
| example D1 | | | | | | | | |
| Comparative | 28.82 | 30.1 | 28.16 | 48.2 | 44.68 | 3/5 | 3/5 | 48.1 |
| example D2 | | | | | | | | |
| Comparative | 43.49 | 26.8 | 52.34 | 20.5 | 54.23 | 3/5 | 3/5 | 20.2 |
| example D3 | | | | | | | | |
| Example D1 | 70.34 | 10.5 | 70.59 | 13.5 | 61.69 | 5/5 | 5/5 | 9.4 |
| Example D2 | 73.28 | 9.4 | 72.68 | 11.4 | 64.37 | 5/5 | 5/5 | 8.3 |
| Example D3 | 72.41 | 9.8 | 70.11 | 12.4 | 60.17 | 5/5 | 5/5 | 9.1 |
| Example D4 | 75.10 | 8.8 | 78.19 | 8.1 | 69.18 | 5/5 | 5/5 | 8.7 |
| Example D5 | 76.54 | 8.4 | 74.18 | 9.3 | 65.11 | 5/5 | 5/5 | 9.0 |
| Example D6 | 71.27 | 10.8 | 76.13 | 9.0 | 67.53 | 5/5 | 5/5 | 9.6 |
| Example D7 | 70.21 | 11.3 | 69.05 | 13.1 | 62.31 | 5/5 | 5/5 | 7.9 |
| Example D8 | 73.36 | 9.6 | 75.64 | 8.6 | 63.26 | 5/5 | 5/5 | 8.0 |
| Example D9 | 56.49 | 25.7 | 38.11 | 35.0 | 56.71 | 2/5 | 2/5 | 21.6 |
| Example D10 | 50.35 | 23.5 | 35.97 | 36.8 | 50.13 | 1/5 | 1/5 | 23.4 |

It can be seen from the results in Table D2 that the battery prepared in the present disclosure through a synergistic effect of the separator and the electrolyte solution and the combination of positive and negative electrode materials can not only effectively improve the battery cycle life and reduce expansion during battery cycling, but can also take into account the low-temperature performance of the battery.

The implementations of the present disclosure are described above. However, the present disclosure is not limited to the foregoing implementations. Any modifications, equivalent replacements, improvements, etc. within the spirit and principle of the present disclosure shall fall within the scope of protection of the present disclosure.

What is claimed is:

1. A battery, comprising a positive electrode plate, a negative electrode plate, a separator disposed between the positive electrode plate and the negative electrode plate, and a non-aqueous electrolyte solution, wherein
the non-aqueous electrolyte solution comprises a non-aqueous organic solvent comprising at least ethyl propionate;
the separator comprises a substrate, a heat-resistant layer, and an adhesive layer, the heat-resistant layer is disposed on at least one side of the substrate, and the adhesive layer is disposed on the heat-resistant layer; the adhesive layer comprises an adhesive comprising a copolymer of hexafluoropropylene-vinylidene fluoride; and
a ratio of a mass percentage of ethyl propionate in the non-aqueous electrolyte solution to a mass percentage of hexafluoropropylene in the copolymer of hexafluoropropylene-vinylidene fluoride ranges from 0.2 to 60.

2. The battery according to claim 1, wherein a ratio of a mass percentage of ethyl propionate in the non-aqueous electrolyte solution to a mass percentage of hexafluoropropylene in the copolymer of hexafluoropropylene-vinylidene fluoride ranges from 0.5 to 35.

3. The battery according to claim 1, wherein the copolymer of hexafluoropropylene-vinylidene fluoride has a number average molecular weight of 200,000 Da to 2,500,000 Da.

4. The battery according to claim 1, wherein the copolymer of hexafluoropropylene-vinylidene fluoride has a number average molecular weight of 500,000 Da to 2,500,000 Da.

5. The battery according to claim 1, wherein the mass percentage of hexafluoropropylene in the copolymer of hexafluoropropylene-vinylidene fluoride ranges from 1 wt. % to 25 wt. %.

6. The battery according to claim 1, wherein the mass percentage of ethyl propionate in the non-aqueous electrolyte solution ranges from 5 wt. % to 60 wt. %.

7. The battery according to claim 1, wherein the non-aqueous organic solvent further comprises at least one of ethylene carbonate, propylene carbonate, dimethyl carbonate, diethyl carbonate, ethyl methyl carbonate, propyl propionate, or propyl acetate.

8. The battery according to claim 1, wherein the non-aqueous electrolyte solution further comprises a lithium salt; and/or
the lithium salt is selected from at least one of lithium bis(trifluoromethanesulfonyl)imide, lithium bis(fluorosulfonyl)imide, or lithium hexafluorophosphate; and/or
a mass percentage of the lithium salt in the non-aqueous electrolyte solution ranges from 13 wt. % to 20 wt. %.

9. The battery according to claim 1, wherein the non-aqueous electrolyte solution further comprises a first additive; and/or
the first additive is selected from at least one of tris(trimethylsilyl) phosphite, tris(trimethylsilyl) borate, lithium bis(trifluoromethanesulphonyl)imide, lithium bis(fluorosulfonyl)imide, 1-propene 1,3-sultone, ethylene sulphite, ethylene sulfate, vinylene carbonate, lithium bis(oxalate)borate, lithium difluorobis(oxalato)phosphate, or vinyl ethylene carbonate; and/or
a mass percentage of the first additive in the non-aqueous electrolyte solution ranges from 0 wt. % to 10 wt. %.

10. The battery according to claim 1, wherein the heat-resistant layer comprises ceramic and a binder.

11. The battery according to claim 10, wherein a mass percentage of the ceramic in the heat-resistant layer ranges from 20 wt. % to 99 wt. %; and/or
a mass percentage of the binder in the heat-resistant layer ranges from 1 wt. % to 80 wt. %.

12. The battery according to claim 10, wherein the ceramic is selected from at least one of aluminum oxide, boehmite, magnesium oxide, boron nitride, or magnesium hydroxide; and/or
the binder is selected from at least one of polytetrafluoroethylene, polyvinylidene fluoride, copolymer of hexafluoropropylene-vinylidene fluoride, polyimide, polyacrylonitrile, or polymethyl methacrylate.

13. The battery according to claim 1, wherein the adhesive layer has a thickness of 0.5 μm to 2 m.

14. The battery according to claim 1, wherein the positive electrode plate comprises a positive electrode current collector and a positive electrode active material layer coated on a surface of either or both sides of the positive electrode current collector, and the positive electrode active material layer comprises a positive electrode active material, a positive electrode conductive agent, and a positive electrode binder; and/or
the positive electrode active material is selected from lithium cobalt oxide or lithium cobalt oxide doped and coated with two or more elements among Al, Mg, Mn, Cr, Ti, and Zr, wherein a chemical formula of the lithium cobalt oxide doped and coated with the two or more elements among Mg, Mn, Cr, Ti, and Zr is LiₓCo_{1-y1-y2-y3-y4}A_{y1}B_{y2}C_{y3}D_{y4}O₂, 0.95≤x≤1.05, 0.01≤y1≤01, 0.01≤y2≤0.1, 0≤y3≤0.1, 0≤y4≤0.1, A, B, C, and D being selected from the two or more elements among Al, Mg, Mn, Cr, Ti, and Zr.

15. The battery according to claim 1, wherein the negative electrode plate comprises a negative electrode current collector and a negative electrode active material layer coated on a surface of either or both sides of the negative electrode current collector, and the negative electrode active material layer comprises a negative electrode active material, a negative electrode conductive agent, and a negative electrode binder; and/or
the negative electrode active material is selected from graphite.

16. The battery according to claim 1, wherein the negative electrode active material further optionally contains SiOₓ/C or Si/C, wherein 0<x<2; and/or
the negative electrode active material further contains 1 wt. % to 15 wt. % SiOₓ/C or Si/C.

17. The battery according to claim 1, wherein the non-aqueous electrolyte solution further comprises a second additive comprising at least one of 1,3-propane sultone, lithium difluoro(oxalato)borate, fluoroethylene carbonate, vinylethylene carbonate, or lithium difluorophosphate.

18. The battery according to claim 17, wherein a mass percentage of 1,3-propane sultone in the non-aqueous electrolyte solution ranges from 0.5 wt. % to 5 wt. %; and/or
a mass percentage of lithium difluoro(oxalato)borate in the non-aqueous electrolyte solution ranges from 0.01 wt. % to 2 wt. %; and/or
a mass percentage of fluoroethylene carbonate in the non-aqueous electrolyte solution ranges from 6 wt. % to 25 wt. %; and/or
a mass percentage of vinylethylene carbonate in the non-aqueous electrolyte solution ranges from 0.01 wt. % to 2 wt. %; and/or
a mass percentage of lithium difluorophosphate in the non-aqueous electrolyte solution ranges from 0.01 wt. % to 2 wt. %.

19. The battery according to claim 1, wherein the mass percentage of ethyl propionate in the non-aqueous electrolyte solution is A_{EP}%; a contact area between the separator and the negative electrode plate is Sₙ m², and a battery capacity is C Ah, wherein A_{EP}, Sₙ, and C satisfy the following relationship: 0.5≤A_{EP}/(Sₙ/C)≤60.

20. The battery according to claim 19, wherein A_{EP}, Sₙ, and C are required to satisfy the following relationship: 2≤A_{EP}/(Sₙ/C)≤40; and/or
the battery capacity C ranges from 0.1 Ah to 100 Ah; and/or
the contact area Sₙ between the separator and the negative electrode plate ranges from 0.0001 m² to 10 m².
